(19) United States
(12) Patent Application Publication
(10) Pub. No.: US 2008/0246284 A1
(43) Pub. Date: Oct. 9, 2008

(54) EASILY ADAPTABLE AND CONFIGURABLE WIND-BASED POWER GENERATION SYSTEM WITH SCALED TURBINE SYSTEM

(75) Inventors: Todd A. Pelman, San Francisco, CA (US); David Elias Hegeman, San Jose, CA (US); Todd Christopher Robinson, San Francisco, CA (US); Jeffrey C. Weintraub, Boulder Creek, CA (US); Oliver Patrick Sjahsam, San Francisco, CA (US)

Correspondence Address: DARBY & DARBY P.C., P.O. BOX 770, Church Street Station, New York, NY, 10008-0770, US

(73) Assignee: Blue Green Pacific, Inc., San Francisco, CA (US)

(21) Appl. No.: 12/062,174

(22) Filed: Apr. 3, 2008

Related U.S. Application Data
(60) Provisional application No. 60/921,891, filed on Apr. 5, 2007.
(60) Provisional application No. 60/967,402, filed on Sep. 4, 2007.

(51) Int. Cl. F03D 9/00; F03D 3/06

(52) U.S. Cl. 290/55; 416/176; 416/198 R; 416/1

(57) ABSTRACT

In one embodiment, a turbine for use in a wind-based power generation system includes a plurality of separate blade parts that contain locating and coupling structures to permit the separate parts to be coupled to one another in a stacked manner to form a shaped blade of the turbine.

This patent application claims the benefit of priority of U.S. Provisional Application Ser. No. 60/921,891, filed Apr. 5, 2007, entitled “Easily Adaptable and Configurable Wind-Based Power Generation System,” and U.S. Provisional Application Ser. No. 60/967,402, filed Sep. 4, 2007, entitled “Easily Adaptable and Configurable Wind-Based Power Generation System with Turbine Control” which are hereby incorporated by reference in their respective entireties.

### TECHNICAL FIELD

The present invention generally relates to wind powered electricity generating systems, especially systems that are optimized for residential use and offer improved ease of manufacture.

### BACKGROUND

The benefits of a small wind powered electricity generation system connected directly to a utility of a dwelling would, in high numbers, have wide technological, social, and economic impact. Since an estimated eight million homes are located in wind producing regions in the United States alone, even a modest portion of these households participating in harnessing wind energy to generate electric power could significantly reduce the reliance on conventional means of power production. Among the social benefits are individual participation and empowerment for a known global issue, increased awareness of a household's electrical use and production which can lessen overall electrical consumption, and a potentially reduced overall environmental impact.

There have been attempts to offer so-called private-use windmills, mostly in the 1970s and early 1980s. Although these systems could indeed generate electricity, the systems themselves had drawbacks which hindered their proliferation. The main problems associated with such small private-use windmills include noise, vibration, appearance, cost, and manufacturing complexity.

Several types of windmill designs are in use. Most are easily recognized as traditional, propeller-based, turbines with a horizontal axis. Additionally, there are several vertical axis designs that are offered in a scale more appropriate for residential urban suburban use. Examples of such designs have been marketed by PacWind (Torrance, Calif.), Loopwing (Japan), Quiet Revolution (England), Windside (Finland), and Turby (Netherlands). Various other designs have been proposed and are disclosed in U.S. Pat. No. 1,697,574, U.S. Pat. No. 3,941,504, U.S. Pat. No. 4,156,580, U.S. Pat. No. 4,218,175, U.S. Pat. No. 4,293,274, U.S. Pat. No. 4,369,629, U.S. Pat. No. 4,427,336, U.S. Pat. No. 4,427,343, U.S. Pat. No. 4,764,683, U.S. Pat. No. 4,718,821, U.S. Pat. No. 4,718,822, U.S. Pat. No. 5,411,422, U.S. Pat. No. 6,428,275, U.S. Pat. No. 6,910,873, and U.S. Pat. No. 7,132,760, incorporated by reference herein.

Predominant barriers to residential wind turbine development have been aesthetics, vibration from the turbine rotor, environmental concerns, performance, installation ease, placement, and efficiency.

### SUMMARY

The present invention overcomes the problems in prior developments, and presents a wind turbine system that is inexpensive, can be customized to wind conditions, and can be easily assembled from modular components. Additionally, it presents a novel method to use a scaled turbine as a tool to analyze both the potential and existing performance of other wind powered electricity generation systems.

A significant feature of the present wind turbine system is that the turbine is formed of modular clusters and blade segment pieces that can be easily assembled and disassembled from the turbine shaft. The implications of this modularity are vast.

The cluster components make the turbine geometry highly adaptable. Each individual turbine can be formed of a different number of clusters, and each of the clusters can have a different geometry. Thus, that the overall shape of the turbine can be optimized for extreme efficiency under a variety of unique conditions. For example, clusters on at the top of the turbine can be larger than clusters at the bottom of the turbine. As such, multiple turbine designs can be developed for generating electricity under various wind conditions. This is especially useful because different seasons can have distinct wind conditions and the turbine can be easily adapted to optimize electricity generation under each new condition. The modularity is also beneficial because a collection of clusters, each with different overall geometry, can be installed on the turbine to overcome obstructions around the installation site.

Since the components are easy to handle, that individuals can purchase turbine kits to produce the greatest amount of energy given the conditions. Additionally, the turbine components to be easily assembled directly at the installation site with ease and improved safety.

Additionally, the clusters comprising the turbine are comprised of a plurality of blade segments that can have identical designs. The result is that the turbine components can be easily mass produced, which greatly decrease the cost of production and can also decrease the final cost to the end user. Ease of use and efficient manufacturing techniques can be combined to deliver improved customer experience, because individuals can easily order standard components to replace worn parts.

In one embodiment, a turbine for use in a wind-based power generation system includes a plurality of separate blade parts that contain locating and coupling structures to permit the separate parts to be coupled to one another in a stacked manner to form a shaped blade of the turbine.

In another embodiment, a turbine for use in a wind-based power generation system includes a plurality of separate, uniform blade parts that mate with one another to form a stacked blade structure that has a Savonius helix shape. Each blade part has locating structures to assist in coupling and stacking the blade parts relative to one another resulting in the Savonius helix shape being formed.

In another embodiment, a wind powered electricity generating turbine system includes a support and mounting structure for mounting the system to a structure and a generator having a rotatable shaft. The generator is configured to generate electricity due to rotation of the shaft. The system also includes a prime mover operatively connected to the generator shaft. The prime mover includes a turbine that is formed of a plurality of blade parts that are interlockingly stacked with one another to define at least one turbine blade. The blade parts are disposed along a turbine shaft that is connected to the generator shaft and is rotatable therewith. The blade parts can be formed of a first set of stacked blade parts and a second set of stacked blade parts that are arranged relative to one another to form a Savonius helix blade shape.

### BRIEF DESCRIPTION OF THE DRAWING FIGURES

Aspects and features of the invention will be more readily apparent from the following Detailed Description, which proceeds with reference to the accompanying drawings, in which:

FIG. 1 is an elevation side view of a segmented turbine system according to one embodiment of the present invention, assembled to a pitched roof top;

FIG. 2 is an elevation side view of the segmented turbine of the system of FIG. 1;

FIG. 3a is an exploded perspective view of a portion of a turbine blade cluster that makes up the segmented turbine;

FIGS. 3b and 3c are perspective and top views, respectively, of a turbine blade cluster that makes up the segmented turbine;

FIGS. 4a and 4b are perspective and bottom views, respectively, of turbine blade segments that make up the segmented turbine;

FIG. 5 is a top plan view of an exemplary turbine support plate that makes up the segmented turbine;

FIG. 6 is an exploded perspective view of the turbine blade cluster and turbine shaft;

FIG. 7 is an exploded perspective of turbine blades for assembly to the shaft for compressingly being held between a coupler and nut;

FIG. 8 is a perspective view of a conventional generator assembly depicted without the aesthetic cover, and a support structure;

FIG. 9 is an exploded perspective view showing the support structure comprised of discrete pole segments;

FIG. 10 is a perspective view of a turbine blade according to another embodiment;

FIG. 11 is a perspective view of a turbine blade cluster formed of the blades of FIG. 10 in combination with support plates to form a turbine cluster;

FIG. 12 is an exploded perspective view of an alternate turbine blade assembly according to another embodiment of the present invention and a turbine shaft;

FIG. 13 is an exploded perspective showing an alternative construction to store and transfer rotational energy along the axis of the turbine to a flywheel;

FIG. 14 is an elevation side exploded view of alternate conventional assembly of generator and turbine support;

FIG. 15 is an elevation side view of a scaled turbine system with a data processing unit;

FIG. 16 is an exploded elevation side view of the scaled turbine system and data measurement tool; and

FIG. 17 is an elevation side view of the scaled turbine system attached to a wind powered electricity generation system.

### DETAILED DESCRIPTION OF VARIOUS EMBODIMENTS

While specific structures, configurations, arrangements and embodiments are discussed below, it should be understood that this is done for illustrative purposes only. A person of ordinary skill in the pertinent art will recognize that other methods, structures, configurations, arrangements, and embodiments can be used without departing from the spirit and scope of the present invention. For example, while the turbine described below is helical, one of ordinary skill in the art will understand how to adapt the methods, structures, configurations, arrangements, and embodiments to other turbine geometries.

By way of overview and introduction, the present invention concerns a wind turbine system that includes a turbine (i.e., prime mover), which is connected to, and drives, a generator by a shaft-to-shaft coupling. As wind rotates the turbine, the generator generates electricity. The generated electricity is delivered to a signal conditioner, such as an inverter, that enables the electricity to be used to power electronic devices. Additionally, there is a support structure that securely mounts the turbine and generator to a natural or human made structure, especially a dwelling.

In another embodiment, a scaled turbine system measures wind speed, potential real time power, accumulated power, green house gas reduction, and other desired parameters. The system can be used to gauge the feasibility and potential performance of a large scale wind turbine system at variable sites with little investment and liability, and can provide valuable feedback and control for the efficient and safe operation of an operable wind powered electricity generation system.

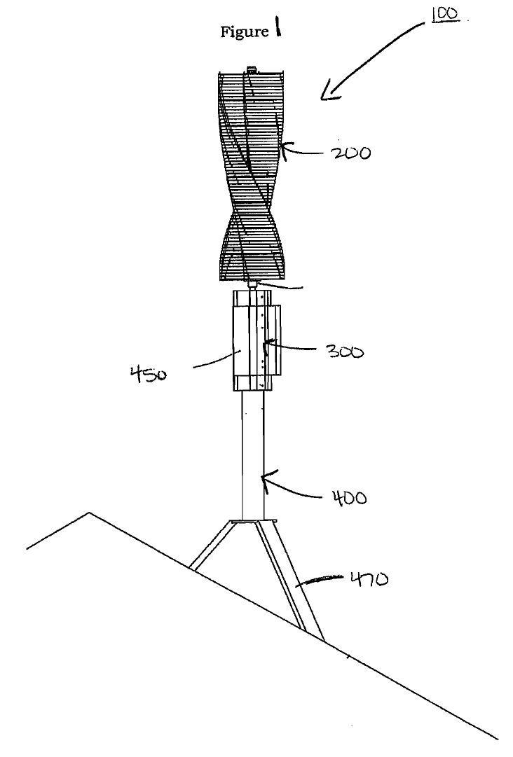

Referring now to FIG. 1, a segmented wind turbine system 100 is illustrated. The segmented turbine system 100 includes a segmented turbine (i.e., prime mover) 200, a generator assembly 300 (see FIG. 8) with an aesthetic generator housing 450, a support structure 400, and a mounting structure 470.

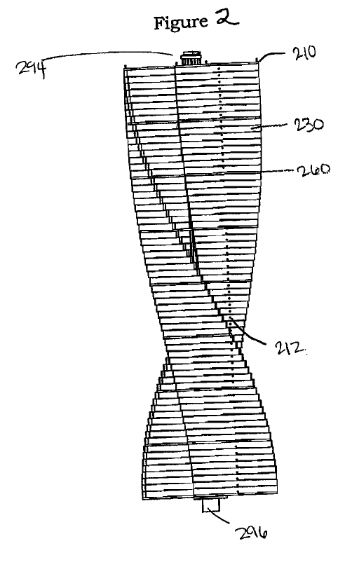

FIGS. 2 through 7 exemplify one structure and construction of the turbine 200.

FIG. 2 illustrates an exemplary turbine and in particular, the turbine 200 is a helical turbine 200 formed of two identical, helically shaped, blades 210. In one embodiment, the helical turbine 200 is in the shape of a Savonius helix. For example, the Savonius helix can be about 6 ft tall and have a diameter of about 2 ft for a typical residential application; however, other sizes are equally possible for different applications. It will also be appreciated that other turbine geometries and dimensions are also acceptable. One suitable blade design is described in U.S. Pat. No. 6,428,275, incorporated herein by reference in its entirety.

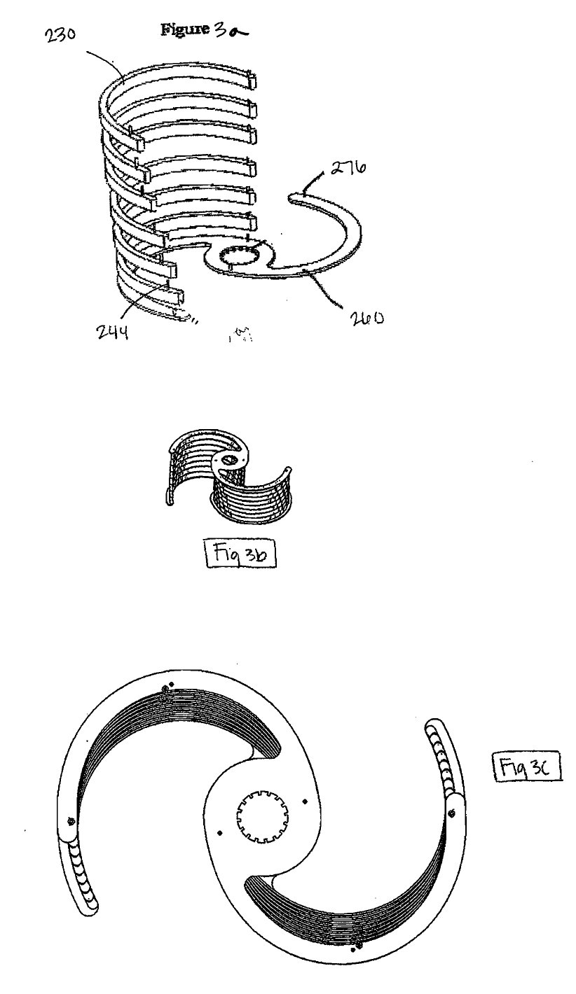

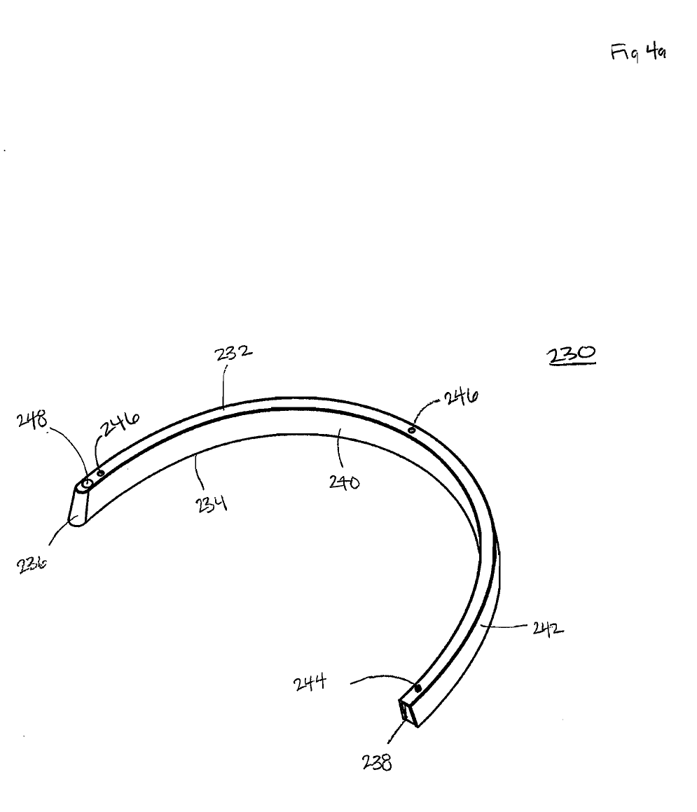

In the illustrated embodiment, the blades 210 are aligned at their extreme ends, and disposed symmetrically around a central shaft 290 (FIG. 2) that rotates in response to wind contacting surfaces of the blades 210. Further, each blade 210 is formed of a plurality of blade segments (planks or blade parts) 230 and at least one support plate 260 that are arranged in a manner described below. Often, blade segments 230 and support plates 260 are assembled into clusters 220 (FIG. 3) prior to assembling the blades 210 of segmented turbine 200. However, assembly at a site is also possible.

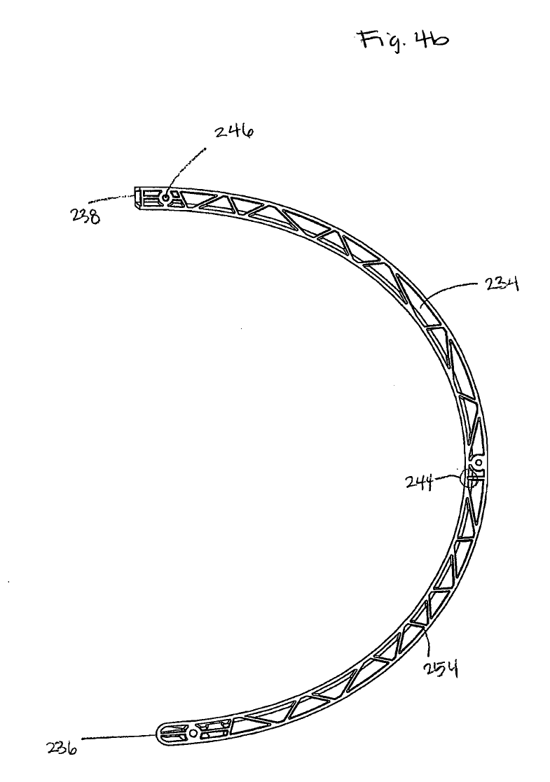

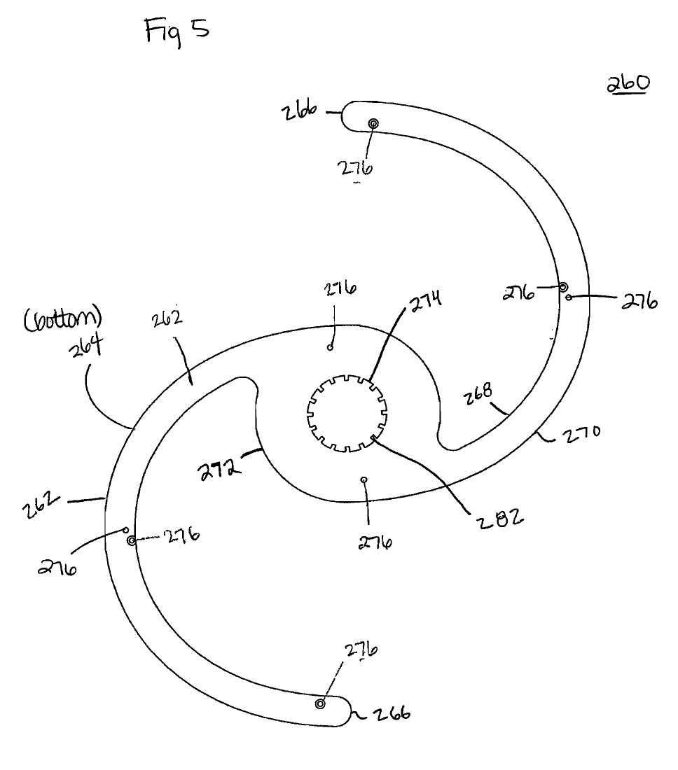

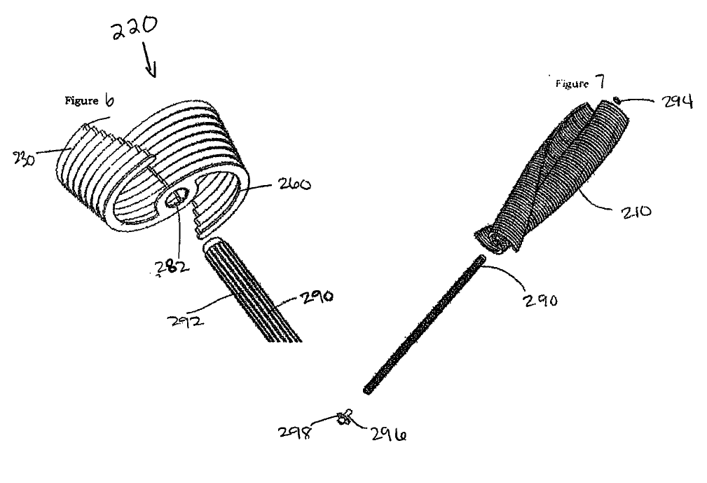

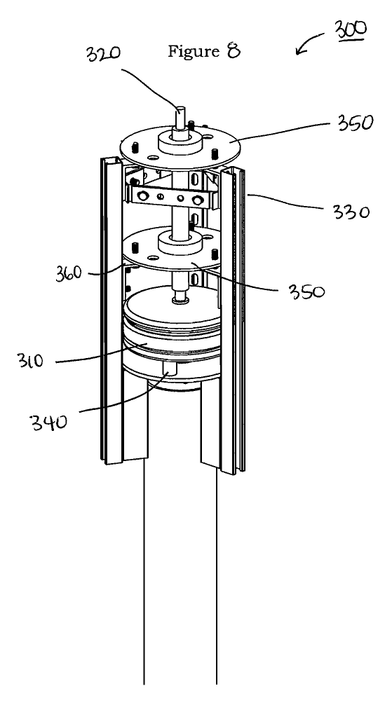

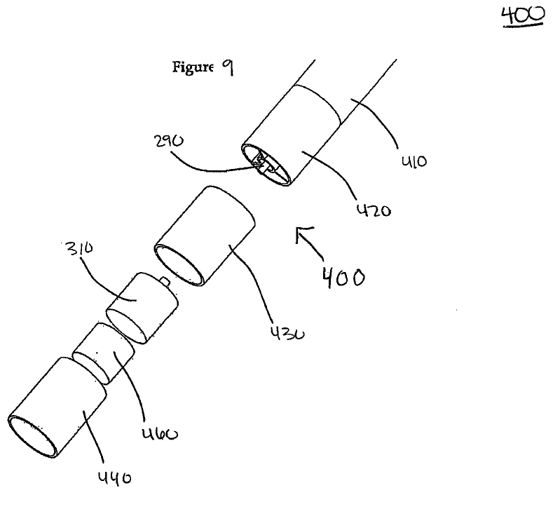

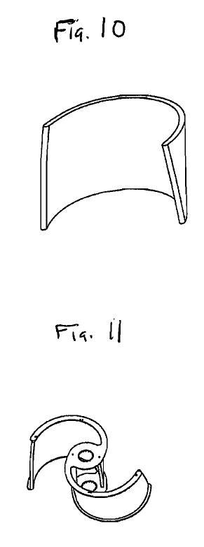

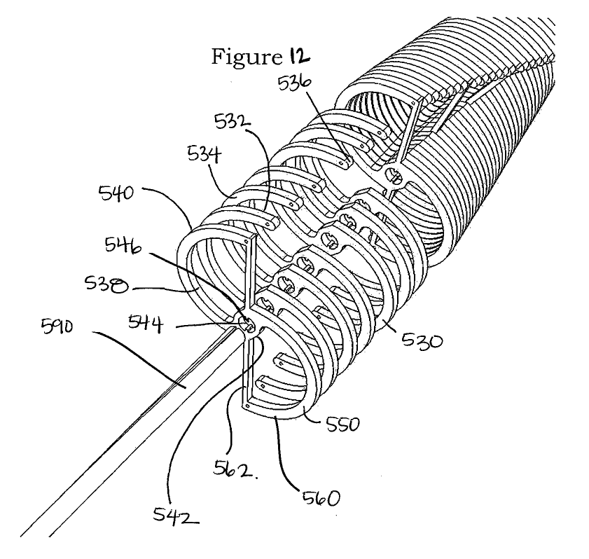

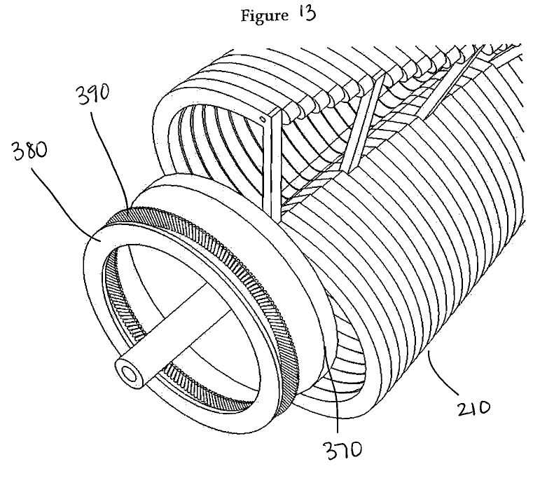

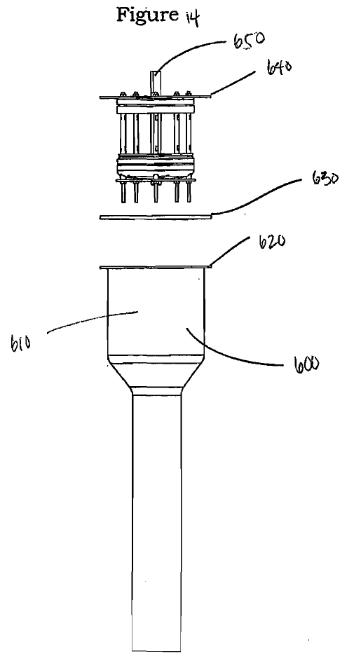

Blade segments 230 (FIGS. 4a and 4b) have a substantially similar cross sectional geometry to blades 210 since the blades are in fact defined by the blade segments. Although the illustrated geometry depicts blade segments with a generally arcuate shape, the blade segments be of an irregular geometry. For example, they can have planer sides, an undulating geometry, or the like. In the illustrated embodiment, each blade segment 230 is identical to all the other blade segments. In some embodiments, blade segments can vary in geometry, for example, if certain parts of the turbine need to be reinforced or have an irregular cross section, then there can be more than one type of blade segment that is used to form the blade 210. However, where the turbine blade shape can be constructed from a plurality of identical blade segments, blade segments with identical geometries are preferred because identical blade segments are easier to assemble and more efficient/cheaper to manufacture. In other words, coding and matching of individual blade segments is not necessary and therefore, a precise order of assembly and mating of blade segments are likewise not needed.

Each blade segment 230 has a generally arcuate shape and is defined by a top and bottom surface or wall 232, 234; first and second ends 236, 238; a first side 240 and an opposing second side 242 that together form a shell 250. In the illustrated embodiment, the shell 250 has a C-shape that is defined by a spline geometry. The first and second ends 236, 238 can have different constructions and in particular, in FIGS. 4a, 4b, and 4c, the first end 236 is a rounded, bevelled (angled) end relative to the top surface 232, which is related to the pitch of the helix. The opposite second end 238 can be a planar edge (e.g., perpendicular to the top surface 232) or it can be slightly angled relative to the top surface 232, which is also related to the pitch of the helix. When the turbine 200 is assembled, the first end 236 represents the outside edge of the blade. The first and second sides 240, 242 can be in the form of vertical walls that are parallel to one another and are perpendicular to the top surface 232. However, the side walls 240, 242 can be in the form of angled sides that form an angle other than 90 degrees with the top surface 232.

In one embodiment, the distance between top surface 232 and bottom surface 234 is approximately 1 inch, the distance between first and second sides 240, 242 is approximately 0.5 inches, and the shortest distance between first and second ends 236, 238 is approximately 12 inches. However, other suitable dimensions are acceptable depending upon the precise application.

The shell 250 can be a substantially hollow member and in addition, it can include a structural reinforcing member that imparts rigidity and robustness to the blade segment 230. For example, a plurality of truss elements 254 (FIG. 4b) can be formed within a hollow inner compartment of the shell, with each truss element extending between and being integrally formed with an inner face of the side walls 240, 242. The shell 250 can be continuous or non-continuous. In the illustrated embodiment, the shell 250 is substantially continuous except for bottom surface 234, which is not continuous. Additionally, in some embodiments, the shell 250 can be substantially solid. It will also be appreciated that the individual blade segments 230 can be identical to one another to permit mass production thereof and to permit the blade segments 230 to be assembled with one another without attention to stacking order, etc.

In order to permit individual blade segments 230 to be coupled to and stacked relative to one another to form the blades of the turbine 200, each individual blade segment 230 has integral structural coupling features that permit each blade segment 230 to be stacked and aligned or interlocked to each adjacent blade segment 230 so as to allow a number of blade segments to be assembled to form the turbine blade(s). In one embodiment, the coupling features include locating pins 244 that are formed at select locations along the blade segment 230. For example, one pin 244 can be formed along and extending outwardly from the top surface 232 near the second end 238. Another pin 244 can be formed along a bottom edge of the shell 250 such that it extends outwardly therefrom. The pin 244 can be formed so that it is located closer to one side wall, such as the first side wall 240 that represents an inner wall of the turbine blade.

The pins 244 can have the same construction or they can have different constructions, e.g., the pin 244 formed along the top surface 232 can have a star shaped cross-section, while the pin 244 formed along the bottom surface 234 can have a rectangular cross-section. The blade segment 230 also has a number of openings 246 that are sized to receive the pins 244 coupling one blade segment 230 to two other blade segments 230. For example, the at least one through hole or opening 246a can be formed in the shell 250 such that it extends from the top surface 232 to the bottom surface 234 and the shell 250 can also include a closed opening 246b that is open along the bottom surface 234 of the shell but not open along the top surface 232.

Adjacent blade segments are optimally secured to each other with fasteners or coupling features. In the present embodiment, the blade segment 230 has a through hole 248 disposed near end 266 of its top surface 232 for securing a stack of blade segments to each other. During assembly of the blade segments, pin 244 near end 238 of a bottom blade segment interlocks with hole 246 near end 238 of a top blade segment, pin 244 in the middle of the top blade segment interlocks with hole 246 in the middle of the bottom blade segment, and a screw is inserted through hole 248 near end 236 of the top blade segment into the hole 246 near end 236 of the bottom blade segment. Subsequent blade segments are continually stacked and secured in the above stated fashion until a desired cluster 220 height is achieved. It will be understood that the above is just one method by which adjacent blade segments 230 can be fastened to one another, and other conventional fastening methods are equally acceptable.

In accordance with the illustrated embodiment, the locating and coupling features are specifically formed and located so that during assembly of the individual blade segments 230 to one another, each adjacent blade segment 230 is radially offset from the adjacent blade segment(s) 230 about the axis of the shaft to create the torsion of the helical shape of the turbine 200. The offsetting in the coupling features results in the beveled first ends 236 being aligned so as to form a generally smooth angled edge of the blade.

Blade segments 230 are stacked onto support plates 260 to make clusters 220 before they are disposed about the shaft 290 to assemble the turbine. FIGS. 3 and 4 illustrate a cluster formed of a plurality of stacked, aligned, and interlocked blade segments sandwiched between support plates 260. Clusters can be formed of any number of blade segments 230 and support plates 260; however, a cluster is typically formed of at least one blade segment 230 and at least one support plate 260. For example, in the illustrated embodiment, the cluster 220 is formed of about 8 rows of blade segments stacked on top of one another (i.e., 16 total blade segments), and is approximately 8 inches tall. Once again, this is merely one exemplary cluster construction that is suitable for one application; and therefore, other cluster constructions are equally possible.

Each support plate 260 has a substantially “S” shaped geometry, as illustrated in FIGS. 3, 5a, and 5b and is defined by a central base portion and a pair of arcuate arms portions that extend radially outward therefrom to form the S-shaped geometry. The support plate 260 is defined by a top and bottom surface or wall 262, 264; ends 266; and a first side 268 and an opposing second side 270. These walls can define a hollow shell construction 280 or the support plate 260 can be a solid structure. In one embodiment, the cross section of the support plate is larger than the cross section of the blade segments so that the distance between first and second sides 268, 270 is greater than the distance between first and second sides 240, 242. Having a larger support plate 260 allows the support plate to better support a stack of blade segments 230 in compression. Additionally, the additional plate material that sticks out beyond the blade segments can counter the manufacturing tolerances of the blade segments and can be used to secure clusters, for example, by fastening together the support plates of adjacent clusters or fastening together the support plates of the same cluster. The distance between the top and bottom surfaces 262, 264 is approximately 0.125 inches; however, other suitable dimensions are acceptable.

The center (base section) of the “S” is an inflection point that divides the “S” into two halves (arcuate arms) with mirror symmetry. Each half of the “S” is defined by a spline geometry defined along the radially extending arm. The inflection point of the plate is occupied by a planar circle having an outer edge 272 and an inner edge 274 that corresponds to an inner opening. The inner opening is for assembling the plate 260 onto the turbine shaft 290, and its diameter is thus similar to the diameter of shaft 290. The inner circle 274 of the plate has plate indexing geometry 282 which corresponds to shaft indexing geometry 292 on the surface of shaft 290. As shown in FIGS. 5, 6, and 7 the indexing geometry 282 and 292 can be ridges along the inner circle 274 of the plate 260 and along the circumference of the shaft 290 that interlock when the plate 260 is assembled onto the shaft 290. However, the indexing geometry depicted in the FIGS. 5, 6, and 7 is for illustrative purposes, and other types of geometries can be used in their place.

When the support plate 260 is in the form of shell 280, it can be a substantially hollow member, and can include structural reinforcing members having similar geometry and function to the blade segment 230 structural members. However, in one preferred embodiment, the support plate 260 is substantially solid, and is made from a rigid, robust material that can transmit rotational forces from the cluster blades 210 to the shaft 290. For example, a metal material or a rigid plastic material can be used.

Each support plate 260 has coupling features which allow it to be coupled to at least one blade segment 230. Plate 260 can have holes 276 formed at select locations for receiving pins or fasteners for coupling to blade segments 230. For example, eight holes 276 can be located along plate 260, one near each end 266, one near each inflection point, and two in each half of the “S” shell. The through hole can extend from the top surface 262 to the bottom surface 264 (not shown) of the shell 280 or it can be a closed opening that is open along the top surface 262 but not open along the bottom surface 264 of the shell, and vice versa, depending on the fastening requirements.

In one embodiment, the same plate geometry is used for each of the top and bottom plates. Each of the holes 276 are equipped for receiving pins 244 of blade segments 230 or fasteners (e.g., screws) that couple the holes 276 of the plate to the holes 246 of the blade segments.

For example, a first blade segment layer is coupled to the bottom plate of the cluster in the following way: a screw fastens the hole 246 at end 236 of the blade segment 230 to the hole 276 at end 266 of the plate 260; a screw fastens the hole 246 at end 238 of the blade segment 230 to the hole 276 near the inflection point of the plate 260; a screw fastens the hole 246 in the middle of the blade segment 230 to the hole 276 closest to side 270 in the half of the “S” shell of the plate 260; and a pin 244 located on the bottom surface 234 of the blade segment 230 interlocks with hole 276 closes to side 268 in the half of the “S” shell of the plate 260.

Continuing with the example, a top blade segment layer is coupled to the top plate of the cluster in the following way: a screw fastens the hole 246 at end 236 of the blade segment 230 to the hole 276 at end 266 of the plate 260; a pin 244 located on the bottom surface 234 of the blade segment 230 interlocks with hole 276 near the inflection point of the plate 260; and a screw fastens the hole 246 in the middle of the blade segment 230 to the hole 276 closest to side 270 in the half of the “S” shell of the plate 260.

It will be appreciated that the coupling members of the support plates 260 and the blade segments 230 are complementary to one another in order to permit a number of stacked blade segments 230 to be mated to and coupled to the support plates 260 in order to form one cluster. For example, the support plate 260 can have complementary locating pins and holes that mate with complementary pins and holes associated with the blade segments so as to allow a stacking and mating of the support plate 260 and the blade segments 230 in a manner in which relative movement (lateral movement) between the parts is minimized. Further, a long pin, which can optionally be integrated with the support plates, can span and secure a plurality of blade segments. Lastly, it will be appreciated that the top and bottom plates of a cluster can have different coupling features so as to better secure the plates to the blades segments.

In a further implementation of the coupling features configuration, an additional long pin can be formed on a surface of bottom plate 260. The long pin can run through a hole 248 of each blade segment 230, can span the entire length of a blade segment 230 stack, and can be used to hold a stack of blade segments together. In a further configuration of the long pin, the long pin can couple to a designated receiving hole in a top plate 260. This coupling structure can be reversed so that the long pin is formed on the surface of top plate 260 and is received in a hole on bottom plate 260. One of ordinary skill in the art will recognize that long pin need not be integral with either support plate 260, but can be a separate feature which is inserted into a designated receiving holes in both bottom plate 260 and top plate 260.

In another embodiment, a single plate can have features so that a single plate can be sandwiched between blade segments 230 after assembling turbine 200. In yet another embodiment, a bottom cluster plate and a top cluster plate can have coupling features so that adjacent top and bottom cluster plates can be interlocked resulting in clusters that can be interlocked to each subsequent cluster. It will be understood that any number of pins or receiving holes can be utilized in the design of either support plates 260 or blade segments 230, but that the coupling features of the blade segments mostly correspond to the coupling features of the plates, and that the coupling features of the plates mostly correspond to the coupling features of the plates.

As suggested previously, stacks of blade segments 230 are added to support plate 260 to form clusters 220 (FIG. 3). In the illustrated embodiment, two stacks of “C” shaped blade segments 230 are added onto the arms of the bottom support plate 260 so that that ends 236 of the bottom layer of blade segments 230 are aligned with the ends 266 of the support plate 260. A support plate 260 is aligned with, and added to, the top layer of “C” shaped blade segments so that that ends 236 of the top layer of blade segments 230 are aligned with the ends 266 of the top support plate 260. The stacks of blade segments 230 are secured to the top and bottom support plates 260 through coupling features such as those described above, or other conventional mechanical interlocking features, such as returns or molded features, location pins, adhesives, and other conventional methods.

It will be appreciated that the clusters 220 disposed along the shaft can be uniform with respect to one another or one or more clusters 220 disposed along the shaft can be different than the others. For example, one or more clusters 220 can have different dimensions (e.g., greater width) compared to one or more other cluster 200 and in this manner, the turbine can be customized depending upon a particular application and the needs of the customer. In other words, a portion of the turbine can be provided with a greater wind contacting surface area by inserting one or more clusters 220 that have greater dimensions than the other clusters 220.

In preparation for assembling the clusters 220 onto turbine shaft 290, a shaft coupling element 296 is assembled to shaft 290 using a conventional method, thereby defining the bottom of the shaft 290 and the lowest possible cluster position, and preventing the blades from sliding below this point (FIG. 7). The coupling element 296 has a flange 298 which contacts the first cluster and provides support for all of the clusters 220 assembled onto shaft 290. The coupling element 296 thus provides a floor or a bottom support surface to permit stacking of the clusters vertically along the shaft.

In order to assemble the clusters 220 onto the turbine shaft 290, each cluster 220 is aligned with the turbine shaft 290 such that its plate indexing geometry 282 is aligned with the turbine shaft indexing geometry 292, and threaded onto the shaft (FIGS. 6 and 7). Each cluster to be added is also aligned with the previously added cluster. In the illustrated embodiment, the bottom support plate 260 of the cluster to be added is substantially aligned with the top support plate 260 of the previously added cluster. Other embodiments can require a different alignment, as to create the desired turbine geometry.

Other mechanical features can be used to rotatably secure clusters to the turbine shaft. For example, clusters can also be secured via other indexing geometries, adhesive, welds, tension wire thread through each blade, geometric features in the blade and support plate, heat shrink membrane, and other usual techniques. Additionally, the blades and support plates can be secured to the shaft via complementary geometries such as flats, guides, spines, threads, keyways, and the like. In a further implementation, geometrical indexing as well as blade or cluster numbering, can be used to assign the cluster order and position with respect to the shaft. In a preferred implementation, the indexing on the shaft and the indexing on clusters are designed so that each cluster is rotated one index tooth relative to the previously assembled cluster during turbine assembly. It will be appreciated that each of these techniques results in the clusters being securely coupled to the shaft so that when the shaft is rotated, the cluster likewise rotate and vice versa.

Following assembly of the clusters on the shaft, a first fastener, such as a threaded nut 294, can be used at the top of the shaft 290 to demark the highest blade position, to prevent the blades from separating from the shaft, and to tighten the blade segments with a compressive force. Other methods by which the blades can be secured include shaft or blade geometry, coupling objects, tensioning cables, threaded nuts, gravity, adhesives, interference fits, and other conventional methods. In other words, by tightening the first fastener 294, the clusters are compressed together so as to tightly join the clusters together so that they all rotate in a uniform manner. The clusters rotate uniformly with one another.

A generator assembly 300 that includes a generator 310 is illustrated in FIG. 8. It will be appreciated that the generator assembly 300 described herein is merely one exemplary construction of a generator assembly; however, other constructions are equally possible so long as they perform the function described herein. Generator 310 is mechanically fastened to shaft 320 and mounted to a rigid support frame 330. The framing support 330 can include any number of framing rails. The framing rails are preferably spaced equally about generator 310. Generator 310 can be mechanically fastened to shaft 320 using threads, keyways, locking coupler, and any conventional fastener, such as bolts and nuts (not shown). Generator 310 and its input shaft 320 can be easily decoupled from frame 330, and removed without disassembling any or most of the components of frame 330. In one embodiment, shaft 320 is integral with generator 310. Having an integral generator shaft reduces the number of coupling junctures, thus improving alignment, reducing, cost, and installation time. It is also preferred that the generator be mechanically connected to a transmission that is integral with a generator housing 450 (FIG. 1) as is conventionally done in generator design.

Generator 310 is further secured in place by a number of components. The generator platen 340 prevents generator 310 from rotating along the generator's axis relative to turbine 200. When shaft 320 is not integral with generator 310, at least one support plate aligns turbine shaft 290 with generator shaft 320. FIG. 8 illustrates a generator assembly having two support plates, for example, axial support plate 350 and radial support plate 360. Axial support plate 350 includes a centrally located bearing which is sized to snugly fit onto generator shaft 320 and is further mechanically secured to the frame using brackets and appropriate fasteners. The brackets and fasteners allow controlled freedom of movement of shaft 320 with respect to the frame 330 so that generator shaft 320 can be adjusted axially. Similarly, radial support plate 360 includes a centrally located bearing which is also sized to fit snugly onto shaft 320 and is further mechanically secured to the frame using brackets and appropriate fasteners. The brackets and fasteners holding radial support plate 360 allow controlled freedom of movement of generator shaft 320 with respect to rails 330 so that generator shaft 320 can be adjusted axially. Other adjustment mechanisms, such as threads, slides, locks, friction, detents, dogs, gears, or the like, adjust the generator height and special position along horizontal the vertical dimensions. The generator assembly structures described above allows for future component replacement due to normal wear or unexpected failure.

Once again, the generator assembly illustrated herein is merely one exemplary type of a generator assembly that can be used with the turbine 200 in order to effectuate the desired motion of the turbine 200.

The turbine, generator assembly, and electrical components are positioned onto the support structure 400 and the mounting structure 470. FIG. 9 illustrates support structure 400 with discrete pole segments 410. Segments include turbine shaft support segment 420, generator support segment 430, and inverter support segment 440. Turbine shaft support segment 420 houses shaft bearings and other elements to secure turbine shaft 290. Generator support segment 430 houses the generator assembly 300. In some implementations, the support segment 430 can be the same as aesthetic housing 450. Inverter support segment 440 houses the electrical conditioner or inverter 460. Other elements, such as elements providing electrical connection and bearing lubrication, can be integrated within the support structure as well. Each of the discrete pole segments 410 can be any size and can be made from multiple segments. Any number of pole segments can be used to construct the final support structure and the exact number depends primarily on the desired height and the support structure geometry.

Finally, a tripod mount 470 (FIG. 1) or the like secures the wind turbine system to its final place of operation. The segmented turbine system can be adapted and secured to any natural or human made structure via the mounting. Such structures include, for example, boats, fields, cars, porches, decks, lawns, parking lots, and store fronts. In one preferred configuration, the segmented turbine system is fastened to a roof top, such as a residential home, and the mount is adapted to the specific roof contour.

The turbine and the generator are mechanically coupled to efficiently transform kinetic energy into electrical energy. In operation, wind blows on the turbine blades 210. The array of blade segments 230 transfer the kinetic energy of the wind to shaft 290 through support plates 260, causing turbine shaft 290 to rotate. Shaft 290 is coupled to generator shaft 320 by way of coupling member 296. The generator's transmission allows a single rotation of turbine shaft 290 to cause multiple rotations of generator shaft 320. In a preferred embodiment, the transmission ratio is 1:1, so that one turn of the turbine results in one turn of the generator. The exact step-up transmission ratio is designed according to a variety of variables, including generator size and type, turbine size, and wind data for the location of installation. Rotation of the generator shaft induces the generator to produce electricity, which is transmitted to output terminals and eventually sent to a controlling circuit.

The segmented turbine system is preferably located and positioned to generate maximal energy. Generally, the segmented turbine system can generate the most energy when the turbine 200 is positioned within a strong and steady wind. Therefore, it is preferred to install the system where it will encounter windy conditions, so that a consistent and predictably high amount of electricity can be generated at the output of generator 310. The generation and storage of electricity is not described in detail since it involves conventional mechanisms and techniques. However, in the preferred system, the segmented turbine operates in parallel to the power grid, and stores any unused energy in said grid.

The components of the segmented turbine system 100 can be formed using conventional materials, techniques, and assembly methods. The blade segments 230 and support plates 260 can be formed of any number of different materials. Suitable materials include polymers, plastics, metals, and the like. In one embodiment, a blade segment 230 is formed of a plastic material, which permits it to be easily manufactured, using conventional techniques, such as a molding process. In another embodiment, a support plate 260 is formed of a metallic material, which imparts greater strength and rigidity. In yet another embodiment, the support frame 330 can be fashioned from any conventional material such as steel, aluminum, or plastic, in any suitable geometry, such as sheets, bars, rods, or the like. Finally, blade segments 230 and support plates 260 can be fabricated according to any conventional methods such as injection molding, blow molding, reaction molding, gas assisted molding, cast, die casting, heat forming, vacuum forming, twist extrusion, sheet metal forming, and cold forming.

In another turbine embodiment, the “C” blade segments 230 forming each cluster 220 are stacked into a cluster formation and covered in a material to provide a smooth turbine appearance (FIGS. 10 and 11). The cover can be applied to the blade segments 230 at any time, including during cluster assembly, after cluster assembly, and after the turbine assembly. The cover can enclose any number of blade segments 230 in any configuration. For example, each stack of blade segments 230 belonging to a cluster 220 can receive a separate cover; a group of blade segment 230 stacks within one cluster 220 can be enclosed in one cover; each entire blade 210 can be enclosed in one cover, the entire turbine 200 can be enclosed in one cover. The cover can conceal any number of blade segments 230, and any number of covers can be utilized. A cover can conceal just the outer surfaces of the blade segments and/or support plates, or it can be rolled over blade segment and/or support plate edges. Covers can be made of any material, and can be applied according to the requirements of the material. For example, the material can be a malleable polymer which can be wrapped onto the blade segments or a preformed plastic can be slid onto the blade segments. Other conventional materials and application methods are acceptable as well.

In an embodiment where a cover is utilized, the underlying structure of each “C” blade segment 230 can be formed of a shell 250 that includes discontinuous surfaces, because the cover will catch the kinetic energy of the wind rather than the surface 240. For example, the shell 250 of the blade segments 230 can be constructed from a wire or mesh geometry. Further, the shape of an entire stack of blade segments 230 that eventually forms the turbine blades 210 can be manufactured from pieces having different geometries, structures, and surface continuities, as long as the final construct has the same shape as a stack of “C” blade segments 230, because the cover preserves the overall appearance of the clusters 220, blades 210, and turbine 200.

In yet another preferred turbine embodiment, a stack of blade segments 230 that includes a cluster 220 is manufactured as one element. This element has a substantially similar shape to the stack of blade segments 230, including the coupling features that couple the blade segments 230 to support plates 260. However, the sides of such an element are smooth. Such an element can be manufactured using conventional materials and methods, such as molding or casting plastics.

In a different turbine embodiment illustrated in FIG. 12, a turbine 200 is formed of a stack of blade segments 530 and support plates 560 that are assembled directly onto a shaft 590. Each blade segment 530 has a substantially “S” shaped geometry, as in FIG. 12, and is defined by a top and bottom surface or wall 532, 534; ends 536; and a first side 538 and an opposing second side 540, that together form a shell 550.

The center of the “S” is an inflection point that divides the “S” into two identical halves with mirror symmetry. Each half of the “S” is defined by a spline geometry. The inflection point of the blade segment 530 is occupied by a planar circle having an outer edge 542 and an inner edge 544 that corresponds to an inner opening. The inner opening is for assembling the blade segment 530 onto the turbine shaft 590, and its diameter is thus similar to the diameter of shaft 590. The inner circle 544 of the blade segment has blade segment indexing geometry 546 which corresponds to shaft indexing geometry 592 on the surface of shaft 590. As shown in FIG. 12, the indexing geometry 546 can be an inlet along the inner circle 544 of the blade segment 530 and a corresponding ridge along the circumference of the shaft 590 that interlock when the blade segment 530 is assembled onto the shaft 590. However, the indexing geometry depicted in the FIG. 12 is for illustrative purposes, and other types of geometries can be used in their place.

The shell 550 can be a substantially hollow member and in addition, it can include a structural reinforcing member that imparts rigidity and robustness to the blade segment 530. For example, a plurality of truss elements can be formed within a hollow inner compartment of the shell, with each truss element extending between and being integrally formed with an inner face of the side walls 538, 540. The shell 550 can be continuous or non-continuous. In the illustrated embodiment, the shell 550 is substantially continuous except for bottom surface 534, which is non-continuous. Additionally, in some embodiments, the shell 550 can be substantially solid. It will also be appreciated that the individual blade segments 530 can be identical to one another to permit mass production thereof and to permit the blade segments 530 to be assembled with one another without attention to stacking order, etc.

The support blade segment 560 in this embodiment is substantially similar to blade segment 530, but has additional structural elements that provide additional rigidity and strength to the turbine structure. One such element is a strut 562 that connects each end 536 of the support blade segment 560 to its inflection point.

During installation, blade segments 530 and support blade segments 560 are assembled onto shaft 590. Blade segments 530 and support blade segments 560 alternate along the length of shaft 590, so that approximately one support blade segment 560 is used for every ten blade segments 530. All blade segments are axially and rotatably secured after assembly onto shaft 590.

In yet another turbine embodiment, an array of light emitting diodes (LEDs) 212 (FIG. 2) can be built into the turbine blade segments, for example, in a vertical orientation. The LEDs can then be connected to a controller and other control circuitry that illuminate the LEDs in accordance with some algorithm. LED messages can include moving messages, moving pictures, or light patterns for aesthetic, informational, or advertising purposes.

The algorithm can be contained and executed in a computer system. The program can process external inputs, such as from a sensor that senses the environment, and output messages. External inputs can be, for example, the rotational speed of the turbine and the amount of ambient light. In one implementation, environmental cues can be incorporated to use the turbine system in a warning system.

In an additional implementation, one or more turbines can be connected to an LED controller, a server, a computer, and other conventional devices, over a computer network, such as the internet. The computer can receive user inputs sent over the internet such as user financial account information, authorization to transfer money from the account of the user to an account associated with server, and a desired LED output, such as an advertisement. The computer can then process the file with the advertisement, parse the advertisement file into an LED compatible format, and send a message to an LED equipped turbine to display the advertisement. In further implementations, a plurality of turbines can be involved in outputting a message, wherein each turbine displays the same, or different, section of the message.

An additional embodiment for effectively transmitting forces from turbine 210 to generator 310 is illustrated in FIG. 13. In this embodiment, a flywheel 370 is coupled onto turbine shaft 290 above support structure 380. The flywheel 370 can be coupled to shaft 290 by conventional means, such as by fastening or welding. Support structure 380 can be the top of support structure 400, a raceway, or a washer. Bearings 390, such as roller bearings, reduce the friction between the flywheel 370 and the top of the support structure 380. When the flywheel spins, it has both momentum and rotational energy, thereby increases the total rotational energy of the turbine, and can be thought of as storing energy. The flywheel utilizes this stored energy during times of need, such as during sporadic wind conditions, to smooth overall turbine operation and energy production. This is especially beneficial during gusty wind conditions, as it provides a mechanism to convert stored energy of the flywheel to usable electrical energy. Additionally, the geometry of the fly wheel can provide a breaking surface when necessary.

In a further embodiment of support structure 400, the generator assembly is housed directly in vessel 610 that is integrated into the support structure, for example, into pole segment 430. FIG. 14 illustrates a generator assembly 300 with a generator plate 640, and a support structure 600 with an integrated vessel 610. During construction, the generator assembly is lowered into the vessel, and the generator plate 640 is aligned with pole flange 620. Generator plate 640 is secured to pole flange 620 by any known methods, including fasteners, clamps, welding, interference fitting, and friction. A gasket 630 can be secured between generator plate 640 and pole flange 620 to reduce potential vibrations and to seal against water.

In a different embodiment, a scaled turbine system 700 can be used to gage the electricity producing potential of a wind turbine system. For example, the scaled turbine system 700 can analyze a location for potential generation of wind energy, identify optimal placement and positioning of an installed wind turbine system, predict the amount of wind energy that a wind turbine system can harvest, establish a proper localized performance metric for safe and reliable operation of a larger wind turbine system, and calculate the reduction in green house gases that result from utilizing a wind turbine system.

The scaled turbine system 700 includes a scaled turbine (pilot turbine) 710, a data processing unit (750, 752, 754, 756, 758), and a universal attachment 760 (FIG. 15). The scaled turbine 710 can be formed of clusters and blade segments similar to the construction of the turbine 200. The turbine 710 can also be one solid piece, a hollow piece, or a hollow piece with internal structure, and can be injection molded, heat formed, vacuumed formed, die-cast, cast, forged, or fashioned by any conventional method. Additionally, the scaled turbine 710 can be made into any geometry that approximates the geometry of the wind turbine undergoing analysis (diagnosis, etc.).

Any blade segments and clusters used to construct scaled turbine 710 are loaded onto scaled turbine shaft 720 and secured axially at the extreme top and bottom using upper turbine fastener 730 and lower turbine fastener 732. The fasteners can be coupling elements, tensioning cables, threaded nuts, fasteners, pins, mechanical clips, gravity, adhesives, friction, welds, interference fits, or the like. Blade segments and clusters are rotationally secured to the shaft with geometrical or any other suitable features that prevent the parts from rotating independent from the shaft.

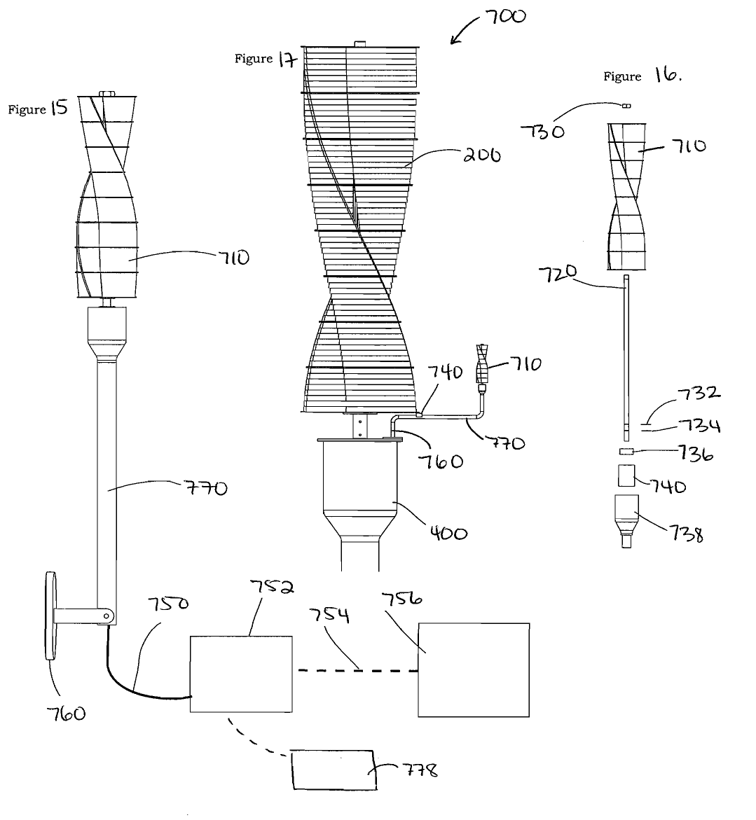

Scaled turbine 710 is assembled to a scaled turbine shaft 720 (see FIG. 16) using features such as returns, molded features, mechanical interlocking/geometric features, adhesive, welds, tension wire threads, heat shrink membrane, adhesive, and the like. Bearings 736, shaft thrust fastener 734, data measurement device (i.e. transducer) 740, and other necessary elements can be added to the shaft. A housing 738 for shielding electrical components can be secured to shaft 720 and pole 770 using, for example, interference fit, clamps, fasteners, internal geometry, friction, welds, brackets, adhesive, threads, or the like. The housing 738 can be configured to house the necessary mechanical and electrical devices.

The scaled turbine 710 is mechanically connected to pole 770, and can be attached using universal mount 760. The height and placement of scaled turbine 710 can be adjusted by adjusting pole 770. The universal mount 760 can have multiple positions, can be permanent or temporary, and can be fastened using tension wires, brackets, suction, or other suitable methods. The assembly can be attached to any desired natural or human made structure, such as residential dwellings, buildings, boats, fields, cars, mechanical structures, porches, decks, laws, parking lots, store fronts, and others.

In order to collect real time operational data, a transducer 740 converts the rotational information from the scaled turbine 710 into a digital signal (see FIG. 16). In a preferred implementation, the transducer is a reed switch, an optically activated indication, a sonically activated indication, a mechanically activated indication, or an encoder. The transducer sends the digital signal to a transmitter 752. The digital signal can be sent through an electrical cable 750, or using wireless communication such as high or low band radio frequency, cell transmission, blue tooth communication, or the like. Transmitter 752 interprets the data, and passes the information 754 to an appropriate device with a feedback interface 756, such as a personal computer, personal digital assistant, cell phone, or any portable or stationary electronic device that can interpret the data using a programmed algorithm. The algorithm can be utilized on a multitude of computing platforms and can provide a user with relevant feedback. In a preferred implementation, the data 754 is also sent to a centralized server 758 that collects, monitors, analyzes, and presents relevant data to any interested party, for example, manufacturer, participating user, and power utility. Analysis of the collected data can be used for any number of different purposes including the planning, design and placement of a larger wind turbine system.

In a further embodiment of the present invention, scaled turbine system 700 operates in conjunction with an operating wind turbine system, such as the segmented wind turbine system 100 or a completely different wind turbine system (FIG. 17). The scaled turbine system 700 acting in conjunction with one or more wind turbine generating systems is assembled directly on to turbine generator support pole 400, so that the autonomous turbine can read the wind conditions of the wind turbine generating system(s). The scaled turbine support pole 770 can be adjusted to achieve an optimal autonomous turbine 710 positioning relative to turbine generator turbine 200. The adjustment mechanisms can be clamps, fasteners, brackets, universal joints, swivels, friction, interlocking geometries between generator pole 400 and scaled turbine support pole 770, or the like. In another implementation, an autonomous turbine transducer 740 can be firmly attached to autonomous turbine pole 400. The location of the transducer can be optimized. For example, the transducer can be located close to the rotating elements of wind generator turbine 200. Additionally, the transducer 740 can be configured to receive operating data from the wind turbine system.

The scaled turbine system working autonomously or in conjunction with a larger wind turbine system(s) has many advantages. For instance, the scaled turbine system gives immediate and aggregated indication of the usable power in the wind, electrical savings, economic savings, and reduction in green house gas emissions, all of which are increasingly important. Currently, no prime movers with subsequent software provide all of the aforementioned pertinent information bundled together. The product provides information such as including electrical production (instantaneous power, for example, in W, and aggregation over time, for example, in kWh), environmental impact (reduction in green house gasses, for example, in lbs of CO₂), and economic value (for example, monthly energy savings). Furthermore, passing relevant data 756 to a centralized server enables users to see their potential production overlaid with geographic data.

Further, a scaled turbine system acting in conjunction with one or more wind turbine generating systems can provide immediate and relevant data to wind generator manufacturers and power utilities. Manufacturers can use the collected data to assess their product against the autonomous turbine metric. The information can indicate wind turbine operating efficiency, failing performance, a need to perform maintenance. Aggregated data can allow manufacturers to identify problems in their product line and create appropriate preventative maintenance plans. Power utilities gain access to relevant data for assessing and making decisions regarding future wind power ventures.

What is claimed is:

1. A turbine for use in a wind-based power generation system comprising:
a plurality of separate blade parts that are coupled to one another in a stacked manner to form a shaped blade of the turbine.

2. The turbine of claim 1, wherein the separate parts include a plurality of blade segments and at least one support plate to which the blade segments are coupled and stacked relative thereto to define a blade of the turbine.

3. The turbine of claim 1, wherein the plurality of blade segments are divided into at least two sets of blade segments, a first set defining a first blade of the turbine, and a second set defining a second blade of the turbine.

4. The turbine of claim 2, wherein the blade segments comprise an arcuate shaped portion that has a defined spline geometry, and wherein each arcuate shaped portion of the blade segment has an inner concave surface and an outer concave surface.

5. The turbine of claim 1, wherein the shaped blade comprises a helically shaped blade, and wherein the turbine has at least two helically shaped blades.

6. The turbine of claim 1, wherein the turbine is shaped like a Savonius helix.

7. The turbine of claim 1, wherein the separate parts contain locating and coupling structures, wherein the separate parts are coupled to one another in an overlying stacked manner, and wherein the separate parts are offset from one another.

8. The turbine of claim 7, wherein the separate parts are radially offset from one another.

9. The turbine of claim 7, wherein the stacked blade segments are offset from one another such that the outer edge thereof forms a smooth beveled blade edge.

10. The turbine of claim 1, wherein each blade part has first locating features formed on a top surface thereof for coupling the part to an overlying adjacent blade part and second locating features formed on a bottom surface thereof for coupling the part to an underlying adjacent blade part.

11. The turbine of claim 10, wherein the first and second locating features are selected from the group consisting of complementary pins and openings.

12. The turbine of claim 2, wherein the support plate comprises a plate having a central base portion that includes an opening for receiving a shaft and radially extending arms.

13. The turbine of claim 12, wherein one set of blade segments are stacked on above one arm of the support plate and another set of blade segments are stacked above the other arm of the support plate, wherein inner concave surfaces of the one set of blade segments face in a direction opposite a direction of inner concave surfaces of the other set of blade segments.

14. The turbine of claim 13, wherein the central base portion includes a pair of locating pins and each of the pair of radially extending arms includes a locating pin, a bottommost blade segment of the one set being coupled at an outer end to the locating pin on one arm and at an inner end to one locating pin on the base portion, and wherein a bottommost blade segment of the other set being coupled at an outer end to the locating pin on the other arm and at an inner end to the other locating pin on the base portion.

15. The turbine of claim 2, wherein the plurality of blade segments is concealed with a cover, and wherein the covered blade segments have a smooth appearance.

16. The turbine of claim 2, wherein the plurality of blade segments and the at least one support plate are concealed with a cover, and wherein the covered blade segments and the at least one support plate have a smooth appearance.

17. The turbine of claim 12, wherein the opening for receiving the shaft has a set of first indexing elements and the shaft has a set of second indexing elements that are complementary to the first indexing elements such that the support plate mates with the shaft in a way that prevents rotation of the support plate relative to the shaft.

18. The turbine of claim 17, wherein the indexing elements define the relative positioning of the blade parts.

19. The turbine of claim 1, wherein each separate part comprises a central base portion that includes an opening for receiving a shaft and a pair of radially extending arms, and wherein each separate part forms an S-shape.

20. The turbine of claim 19, wherein the separate parts include a plurality of blade segments and at least one support plate, wherein the blade segments are stacked on above the support plate, and wherein the arms of the blade segments align with the arms of the support plate.

21. The turbine of claim 1, wherein the parts have integral LED lights.

22. A wind powered electricity generating turbine system comprising:
a support and mounting structure for mounting the system to a structure;
a generator having a rotatable shaft, the generator being configured to generate electricity due to rotation of the shaft; and
a prime mover operatively connected to the generator shaft, wherein the prime mover includes a turbine that is formed of a plurality of blade parts that are interlockingly stacked with one another to define at least one turbine blade, the blade parts being disposed along a turbine shaft that is connected to the generator shaft and is rotatable therewith.

23. A method of designing, positioning or monitoring the performance of a turbine for use in a wind powered electricity system comprising the steps of:
providing a first turbine system having a first scale and including a turbine that is segmented along its vertical axis into individual parts that each includes locating and coupling structures to permit the separate parts to be coupled to one another in a stacked manner so as to define at least one turbine blade, the first turbine system including a transducer, a data transmitter, and a computer processor; and
transmitting data regarding wind conditions to the computer processor, wherein the computer processor includes software to compute the potential electrical production, environmental impact, and economic value of a wind powered electricity generating turbine system that has a second scale different from the first scale.

24. The method of claim 23, further including the step of:
operatively connecting the turbine having the first scale, the transducer, and the data transmitter to a second turbine, wherein the computer processor compares an output of the second turbine with the first turbine having the first scale, and calculates a theoretical and actual productivity of the second turbine.
